(19) United States
(12) Patent Application Publication
(10) Pub. No.: US 2026/0312453 A1
(43) Pub. Date: Oct. 8, 2026

(54) Triple Stator Homopolar Alternator

(71) Applicant: C.E. Niehoff & Co., Evanston, IL (US)

(72) Inventors: Stoyan Bekiarov, Wilmette, IL (US); Thomas Nadolny, Bolingbrook, IL (US)

(73) Assignee: C.E. Niehoff & Co., Evanston, IL (US)

(21) Appl. No.: 19/169,827

(22) Filed: Apr. 3, 2025

(51) Int. Cl. H02K 3/28; H02K 1/26; H02K 7/18

(52) U.S. Cl. CPC H02K 3/28; H02K 1/26; H02K 7/1807

(57) ABSTRACT

A triple-stator homopolar alternator described herein provides a novel design for increased electrical power output within a physical diameter constraint, where the electrical power output is proportional to the alternator's axial length for a fixed outer diameter. The triple-stator homopolar alternator includes a rotor assembly comprising a rotor core supporting three rotor components on a rotating shaft. A first field coil is positioned around the rotor core between a first rotor component and a second rotor component and a second field coil is positioned around the rotor coil between the second rotor component and a third rotor component. Each of the first, second, and third rotor components are adjacent to corresponding stator assemblies. Excitation flux from each field coil combines in the second rotor/stator component and avoids shell and rotor core magnetic saturation to double power generation capability of a two-stator homopolar machine having the same diameter.

### BACKGROUND

Rotating machines are used in many applications such as to convert mechanical energy to electrical energy and/or to convert electrical energy to mechanical energy. An illustrative rotating machine may be used in a power generation application, such as an alternator or other electrical power generator for a vehicle. Vehicle alternators may be driven by a belt coupled to the vehicle's engine to facilitate electrical power generation. A vehicle electrical system in modern vehicles include large numbers of electrical components that consume large amounts of electrical power. Consequently, vehicle electrical systems use one or more high power generators to meet the high electrical power requirement. Vehicle alternators may be designed using one of a number of different topologies, such as a salient-pole wound-field synchronous alternator, a non-salient-pole wound-field synchronous alternator, a Lundell alternator, and a homopolar inductor alternator, and the like.

Homopolar generators (e.g., homopolar alternators) offer multiple advantages over other designs including, for example, simple construction using components made of easily sourced materials (copper wire, soft magnetic steel, electric steel, iron, and the like) that do not rely upon rare earth materials. As such, the homopolar alternators offer high manufacturability. Further, homopolar alternators reliably operate over a wide constant power speed range. Additionally, homopolar alternators are capable of high-speed operation, while meeting torque requirements of vehicle markets, particularly in the medium and/or heavy-duty vehicular markets.

Existing designs of homopolar alternators provide high-quality electrical power to multiple electrical components within a vehicle's electrical system. However, these existing designs include some limitations. For example, due to an increase in electronics, engine size, cooling equipment and an overall increase of vehicular components, due to increased vehicular system complexity, available space within an engine compartment for alternator placement has been reduced. As such, the size and shape of vehicular alternators has become a limiting factor for providing sufficient electrical power to the vehicular electrical system. For example, an engine compartment volume dedicated for alternator mounting may have limited axial and/or radial space, thus limiting the size of the homopolar alternator capable of meeting the available dimensions within the engine compartment. Due to these size constraints, a maximum available output power of the homopolar alternator sized to fit within vehicle's engine compartment is likewise limited.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome the above-noted problems, a need has been recognized for a rotating assembly of a generator of electrical power that allows for increasing alternator power output without increasing the exterior diameter of the alternator. As mentioned above, electrical power needs for vehicles continually increases for both vehicular features and for powering devices external to the vehicle. Due to limitations with available space within a vehicle's engine compartment, new alternator designs are needed to provide enough electrical power for current and future needs within the physical constraints resulting from vehicular design necessities. The triple stator homopolar alternator described herein provides a novel design that allows for increased electrical power output within a physical diameter constraint, where the power output is proportional to the alternator's axial length for a fixed outer diameter.

These features, along with many others, are discussed in greater detail below.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps may be optional. It will also be appreciated with the benefit of this disclosure that one or more components illustrated in the accompanying figures may be positioned in other than the disclosed arrangement and that one or more of the components illustrated may be optional, in which:

FIG. 1 shows a partial cross-sectional view of a single stator homopolar machine;

FIG. 2 shows a partial cross-sectional view of a double stator homopolar machine; and

FIG. 3 shows a partial cross-sectional view of a triple stator homopolar machine, according to aspects of the disclosure.

### DETAILED DESCRIPTION

In the following description of various example structures and methods in accordance with the invention, reference is made to the accompanying drawings, which form a part hereof, and in which are shown by way of illustration various fitness devices and systems using fitness devices in accordance with various embodiments of the invention. Additionally, it is to be understood that other specific arrangements of parts and structures may be utilized and structural and functional modifications may be made without departing from the scope of the invention.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof, as well as additional items and equivalents thereof. As used in this description, a set refers to a collection of one or more elements.

A homopolar alternator uses a field coil to induce a magnetic flux through one or more stator windings. The power delivered to the field coil may be much less than the generated output power of the alternator. A homopolar alternator may utilize homopolar magnetic flux when a magnetic flux component within a stator alternates between high magnetic flux and low magnetic flux without reversing direction between its north and south orientation. Additionally, a net magnetic flux through a rotor core and a shell of a homopolar alternator may be constant. In general, an alternator (e.g., a homopolar brushless alternator) may include a field coil that generates a magnetic flux when a field current passes through the field coil. The magnetic flux interacts with one or more stator windings in the alternator to induce a voltage across the stators which, in turn, produce an output current for consumption by an electrical load, such as vehicular components and/or other electrical accessories connected to a vehicle electrical system.

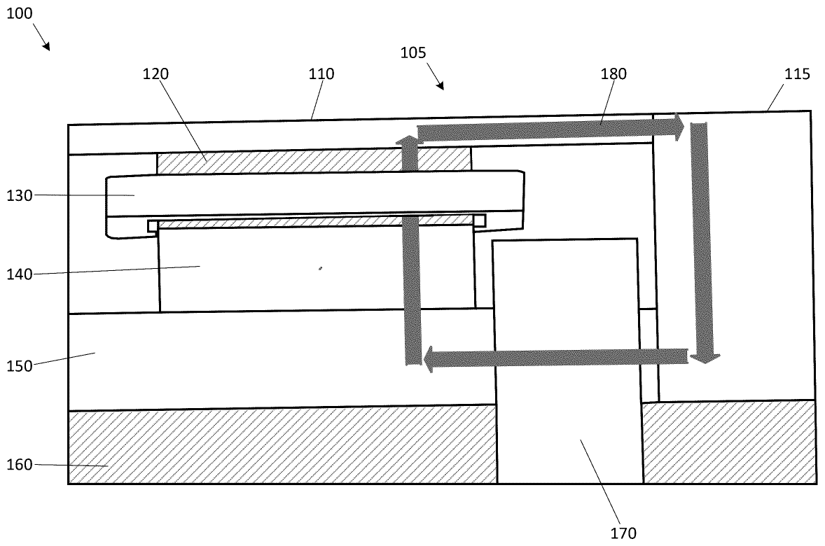

A synchronous machine 100, a portion of which is shown in FIG. 1, is a homopolar inductor alternator. The homopolar inductor alternator generates alternating flux in an air gap by varying the reluctance of the rotor. The magnetic circuit 105 of the synchronous machine 100 comprises five main parts, a shell 110, a stator 120, a rotor 140, a rotor core 150, and a housing 115. In some cases, the shell 110 may form a portion of the housing 115. The synchronous machine 100 may further include electrical components, such as one or more stator coils, such as the stator coil 130, and a field coil 170. The stator coil 130 and the field coil may be made from electrically conductive material, such as a copper wire. The shell 110 may be made of soft magnetic steel, the stator 120 may be made from electric steel laminations, the rotor 140 may be made from electric steel laminations or from solid soft magnetic steel, the rotor core 150 may be made from soft magnetic steel and may be fit onto a rotor shaft 160, and the housing 115 may be made from soft magnetic steel. The housing 115 may form a return path of magnetic flux path 180 induced from an electrical current generated from an electrical current flowing through the field coil 170.

The synchronous machine 100 shown in FIG. 1 is of a single stator configuration. Such machines are typically used in applications where the axial length of the synchronous machine must be kept as short as possible. As such, a disadvantage of this single stator configuration is that the portion of the magnetic flux path 180 through the housing 115 is not utilized, since there are no windings in the housing 115. For this reason, the single stator configuration of the synchronous machine suffers from low efficiency and its application is usually limited to applications that may utilize low power machines.

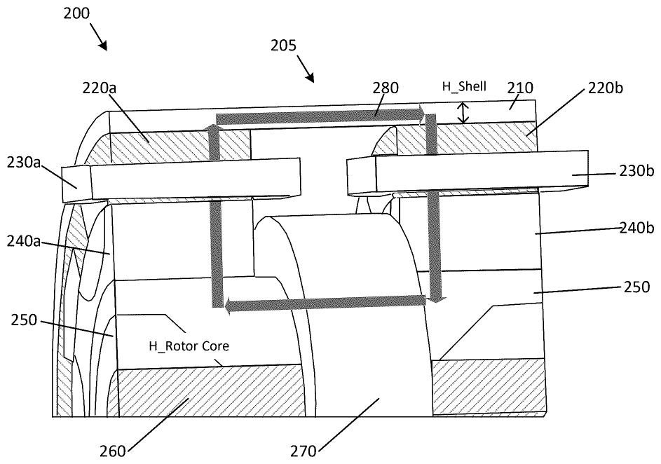

To improve efficiency of homopolar machines, a two-stator configuration has been introduced and is currently the most popular design of homopolar synchronous machines. The two-stator configuration includes a second stator that is introduced to utilize the return flux as shown in the partial cross-sectional view of the two-stator homopolar alternator 200 shown in FIG. 2. The magnetic circuit 205 of the two-stator homopolar machine 200 includes, among others, six main parts including a shell 210, a front stator 220a, a front rotor 240a, a rotor core 250. a rear rotor 240b, and a rear stator 220b. The two-stator homopolar alternator 200 may further include electrical components, such as a field coil 270 positioned around the rotor core 250 between the front rotor 240a and the rear rotor 240b. Additionally, the electrical components may further include a plurality of stator coils, such as a front stator coil 230a and a rear stator coil 230b. The field coil 270 and the stator coils, such as the front stator coil 230a and the rear stator coil 230b may be formed from a conductive material, such as copper wire. The shell 210 may be made from soft magnetic steel, the front stator 220a and the rear stator 220b may be made from electric steel laminations, the front rotor 240a and the rear rotor 240b may be made from electric steel laminations or from solid soft magnetic steel, and the rotor core 250 may be made from soft magnetic steel and fit onto a rotor shaft 260. The shell 210 may comprise at least a portion of a housing for the alternator that surrounds a stator assembly of the alternator.

The power output of the two-stator homopolar alternator 200 is proportional to its axial length for a fixed outer diameter. Further, the power output of the two-stator homopolar alternator 200 is limited by the cross-sectional area of the shell and the rotor core. For example, the power output is limited by one or both of the thickness (H_shell) of the shell 210 and/or the thickness (H_rotor core) of the rotor core 250. The power output of the two-stator homopolar alternator 200 increases with respect to an increase of the axial length of the two-stator homopolar alternator 200 until the whole flux in a flux path 280 created by the field coil 170 and flowing through the middle portion of the shell 210 and rotor core 250 is captured by the stator windings (e.g., the front stator coil 230a and the rear stator coil 230b) that are wound around the stator poles (e.g., one or more stator poles of the front stator 220a and the rear stator 220b). Once all the flux that can be passed through the middle portion of the shell and rotor core is utilized by the stator and rotor pairs, no additional power gain can be achieved by increasing the length of the two-stator homopolar alternator 200. Hence the thickness of the shell 210 and/or the thickness of the rotor core 250 limit the amount of power that can be delivered for a fixed outer diameter of the two-stator homopolar alternator 200. This limit is due to the magnetic flux saturation in the middle portions of the shell and/or the rotor core. Once this limit is reached, the only way to increase the power output of the two-stator homopolar alternator 200 is to select another (e.g., physically larger) alternator having an increased outer diameter.

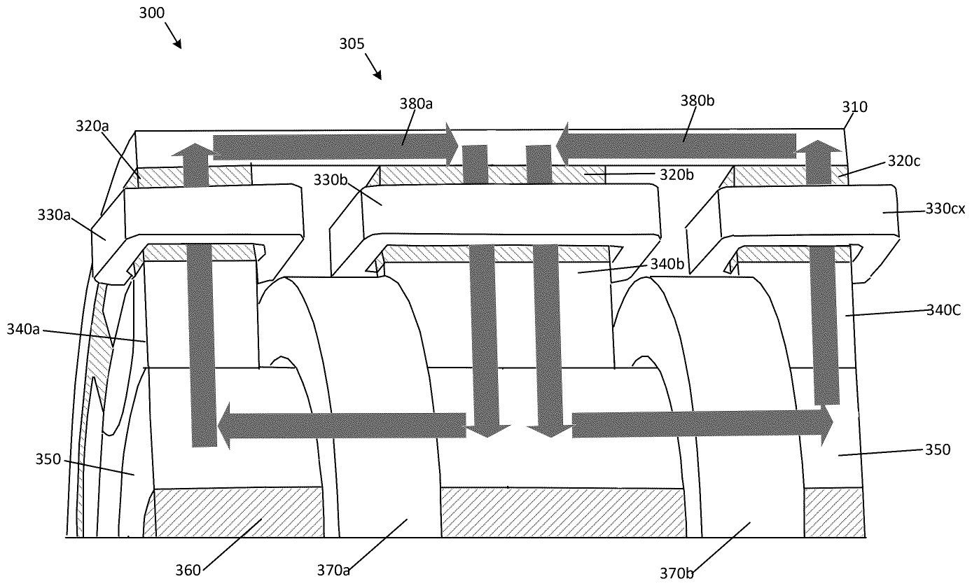

In some applications, the available space for mounting an alternator (e.g., within an engine compartment of a vehicle), is insufficient for accommodating an alternator with a larger diameter. However, the space available may accommodate a longer alternator. By allowing vehicle designers to design and/or configure an interior space of a vehicle for mounting a longer higher power alternator, the resulting vehicle may accommodate a greater demand for available power from integrated and/or externally connected electrical components. The triple-stator homopolar alternator, such as the triple-stator homopolar alternator 300 of FIG. 3, provides a solution for such applications.

The components of the triple-stator homopolar alternator 300 comprises a magnetic circuit 305 including eight main parts, including, for example, a shell 310, a front stator 320a, a front rotor 340a, a rotor core 350, a middle stator 320b, a middle rotor 340b, a rear stator 320c, and a rear rotor 340c. The triple-stator homopolar alternator 300 may further include electrical components, such as a front field coil 370a positioned between the front rotor 340a and the middle rotor 340b and a rear field coil 370b positioned between the middle rotor 340b and the rear rotor 340c. Additionally, the electrical components may further include a plurality of stator coils, such as a front stator coil 330a, a middle stator coil 330b, and a rear stator coil 330c. The field coils (e.g., the front field coil 370a and the rear field coil 370b) and the stator coils (e.g., the front stator coil 330a, the middle stator coil 330b, and the rear stator coil 330c) may be formed from a conductive material, such as copper wire. The shell 310 may be made from soft magnetic steel, the front stator 320a, the middle stator 320b, and the rear stator 320cx may be made from electric steel laminations. The front rotor 340a, the middle rotor 340b, and the rear rotor 340c may be made from electric steel laminations or from solid soft magnetic steel. The rotor core 250 may be made from soft magnetic steel and fit onto a rotor shaft 360. The shell 210 may comprise at least a portion of a housing for the alternator that surrounds a stator assembly of the alternator.

The triple-stator homopolar alternator 300 resolves the problem of the magnetic flux saturation in the middle portions of the shell 310 and the rotor core 350 by adding a second field coil (e.g., the rear field coil 370b) on an opposite side of the middle rotor 340b and by adding a third stator/rotor pair (e.g., the rear stator 320c and the rear rotor 370c) at the opposite side of the rear field coil 370b in order to utilize the return flux of the rear field coil 370b. In this way, the output of the triple-stator homopolar alternator 300 can be double that of the output of a two-stator machine (e.g., the two-stator homopolar alternator 200) with the same outer diameter.

The front field coil 370a and the rear field coil 370b may have the same number of turns and may be wound in the opposite direction. In some cases, the front field coil 370a and the rear field core 370b may be wound in a same direction. In some cases, the front field coil 370a and the rear field core 370b may be wound with a different number of turns. For example, the number of turns of the front field coil 370a and the number of turns of the rear field coil 370b may be within a range of turns (e.g., within +/− two turns, within +/− four turns, within +/-− ten turns, and the like). The excitation current applied to each of the field coils creates a magnetic flux (e.g., shown in a magnetic flux path 380a and a magnetic flux path 380b) that combines (e.g., adds) in the middle section of the triple-stator homopolar alternator 300 (e.g., the middle stator 320b, middle rotor 340b pair). For example, when wound in the same direction, the current applied to each of the front field coil 370a and the rear field core 370b may be of an opposite polarity. In cases, when the front field coil 370a and the rear field core 370b are wound in opposite directions, the current may be applied to both the front field coil 370a and the rear field coil 370b with the same polarity.

The middle stator 320b, middle rotor 340b pair section is twice as long as the front portion (e.g., the front stator 320a, front rotor 340a pair section) and the rear portion (e.g., the rear stator 320c, rear rotor 340c pair section), because this middle section must handle twice the magnetic flux (e.g., an additive combination of the flux path 380a and the magnetic flux path 380b) as compared to the front and rear sections. In essence, the fact that the excitation flux from each field coil is combined in the middle section of the triple-stator homopolar alternator 300 removes the limiting factor resulting from the shell and/or rotor core magnetic saturation. Additionally, the configuration of the middle stator 320b, middle rotor 340b pair section allows for doubling power generation capability of the triple-stator homopolar alternator 300 compared to a similar two-stator homopolar machine having the same diameter.

Further, the stator windings of the middle stator 320b may have half the numbers of turns as the windings in the front stator 320a and the rear stator 320c, so that the back emfs generated in all 3 sections are the same. This configuration allows the front stator 320a, the middle stator 320b, and the rear stator 320c to be connected in parallel. Alternately, the stator windings in the front stator 320a, the middle stator 320b, and the rear stator 320c can be connected in series if desired, such as in high voltage applications.

What is claimed, is:

1. An alternator, comprising:
a shell;
a first stator;
a first rotor adjacent to the first stator and forming a first stator/rotor pair;
a second stator;
a second rotor adjacent to the second stator and forming a second stator/rotor pair;
a third stator;
a third rotor adjacent to the third stator and forming a third stator/rotor pair;
a first field coil generating a first magnetic flux, wherein the first field coil is between the first stator/rotor pair and the second stator/rotor pair; and
a second field coil generating a second magnetic flux, wherein the second field coil is between the second stator/rotor pair and the third stator/rotor pair; and
a power output electrically connected to the first stator, the second stator, and the third stator, wherein electrical power output by the alternator is proportional to an additive combination of the first magnetic flux and the second magnetic flux.

2. The alternator of claim 1, wherein the first magnetic flux and the second magnetic flux pass through the second stator/rotor pair.

3. The alternator of claim 1, wherein the first field coil and the second field coil are wound in an opposite direction.

4. The alternator of claim 1, wherein the second stator/rotor pair has a greater axial length than the first stator/rotor pair or the third stator/rotor pair.

5. The alternator of claim 1, wherein the second stator/rotor pair has an axial length twice than that of the first stator/rotor pair or the third stator/rotor pair.

6. The alternator of claim 1, wherein a first amount of magnetic flux in the first stator/rotor pair is less than an amount of second magnetic flux in the second stator/rotor pair and wherein a third amount of magnetic flux in the third stator/rotor pair is less than the amount of second magnetic flux in the second stator/rotor pair.

7. The alternator of claim 1, wherein a first number of turns of the first field coil is similar to a second number of turns of the second field coil.

8. The alternator of claim 1, wherein a third number of turns of first stator windings of the first stator is about twice a fourth number of turns of second stator windings of the second stator and wherein a fifth number of turns of third stator windings of the third stator is about twice the fourth number of turns of the second stator windings.

9. The alternator of claim 1, wherein a maximum power output is proportional to an axial length of the alternator for a given outer diameter of the alternator.

10. An electrical generator comprising:
a housing comprising a shell surrounding a stator assembly, the stator assembly comprising a first stator section, a second stator section, and a third stator section;
a rotor assembly, comprising:
a shaft;
a rotor core surrounding the shaft;
a first rotor section adjacent to the first stator section, a second rotor section adjacent to the second stator section, and a third rotor section adjacent to the third stator section;
a first field coil positioned between the first rotor section and the second rotor section; and
a second field coil positioned between the second rotor section and the third rotor section; and
wherein electrical power output by the electrical generator is proportional to an additive combination of first magnetic flux associated with the first field coil and second magnetic flux associated with the first field coil.

11. The electrical generator of claim 10, wherein the first magnetic flux and the second magnetic flux pass through a second stator/rotor pair.

12. The electrical generator of claim 10, wherein the first field coil and the second field coil are wound in a same direction.

13. The electrical generator of claim 10, wherein a second stator/rotor pair has a greater axial length than a first stator/rotor pair or a third stator/rotor pair.

14. The electrical generator of claim 10, wherein a second stator/rotor pair has an axial length twice that of a first stator/rotor pair or a third stator/rotor pair.

15. The electrical generator of claim 10, wherein magnetic flux in a second stator/rotor pair is greater than an amount of first magnetic flux in a first stator/rotor pair and in a third stator/rotor pair.

16. The electrical generator of claim 10, wherein a first number of turns of the first field coil is similar to a second number of turns of the second field coil.

17. The electrical generator of claim 10, wherein a third number of turns of first stator windings of the first stator section is twice a fourth number of turns of second stator windings of the second stator section and wherein the third number of turns of the first stator windings is the same as a fifth number of turns in the third stator windings of the third stator section.

18. The electrical generator of claim 10, wherein a maximum power output is proportional to an axial length of the electrical generator for a given outer diameter of the electrical generator.
